(19) United States
(12) Patent Application Publication
(10) Pub. No.: US 2018/0103341 A1
(43) Pub. Date: Apr. 12, 2018

(54) SYSTEM FOR LOCATION BASED AUTHENTICATION

(71) Applicant: BANK OF AMERICA CORPORATION, Charlotte, NC (US)

(72) Inventors: Samuel Massa Moiyallah, JR., Newark, DE (US); Joseph Benjamin Castinado, North Glenn, CO (US)

(21) Appl. No.: 15/287,553

(22) Filed: Oct. 6, 2016

(51) Int. Cl. H04W 4/02; H04W 12/06; H04L 29/06; G06Q 20/40; G06Q 20/10; G06F 3/0482; G06F 3/0481; G06F 3/0488

(52) U.S. Cl. CPC H04W 4/021; H04W 12/06; H04L 63/08; H04L 63/107; G06F 3/0488; G06Q 20/10; G06F 3/0482; G06F 3/04817; G06Q 20/4014

(57) ABSTRACT

Embodiments of the present invention describe systems for authenticating an identity of a user or a mobile device of the user. As such, when an event associated with the user is determined to be occurring, an authentication code is generated but not immediately sent to the mobile device of the user. Instead, location information of the mobile device is continuously monitored, and the authentication code is transmitted only when the mobile device is determined to be within a predetermined distance of a certain authentication location. This authentication code can then be presented by the user or the mobile device to authenticate the user for completion of the event.

### FIELD OF THE INVENTION

The present invention is generally directed to systems, methods, and computer program products for location based authentication of users or devices.

### BACKGROUND

Authentication of users and/or devices associated with users is an important security function in some Internet and other computer network system environments. Data can be kept secure if a computing system has a high degree of certainty that a user accessing an electronic device is the person or entity they claim to be or represent. A current solution is to transmit a two-step verification code to a device that has been registered by a user, so the user can present the two-step verification code along with identity credentials like usernames, passwords, photo identification, and the like. However, this current method does not provide protection against a situation where a person other than the user finds or otherwise acquires the registered device of the user and therefore can access the two-step verification code.

Therefore, a need exists to provide a more secure technique of transmitting a verification code to a user that increases the likelihood that an individual presenting a verification code is the actual verified user. This need and others are addressed herein.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for location-based authentication of users and/or electronic devices associated with the users. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The system may involve providing an authentication application to a user for installation on a mobile device of the user, and determine that an event associated with the user is occurring, wherein the event requires authentication of an identity of the user for completion. In response to determining that the event is occurring, the system may generate an authentication code associated with the event and continuously monitor location data of the mobile device to determine a location of the mobile device. Through monitoring the location data of the mobile device, the system determines that the mobile device of the user is within a predetermined distance of an authentication location. In response to determining that the mobile device of the user is within a predetermined distance of the authentication location, the system automatically transmits an alert across a wireless network to the mobile device of the user, wherein the alert activates the authentication application, causing a user interface of the mobile device to display the authentication code. The system may then receive a transmission of the authentication code from a computing device associated with the event and, in response to receiving the transmission of the authentication code, authenticate the identity of the user for completion of the event.

In some embodiments, the system may, in response to providing the authentication application, transmit an authentication location alert to the mobile device of the user, wherein the authentication location alert activates the authentication application, causing a user interface of the mobile device to display a request for input of a geographic location to be assigned as the authentication location. In some such embodiments, the system may receive, from the mobile device of the user, the input of the geographic location and assign the geographic location as the authentication location. In other such embodiments, the system may receive, from the mobile device of the user, user input of multiple geographic locations, and assign the multiple geographic locations as the authentication location.

In embodiments of the system, the step of determining that the mobile device of the user is within the predetermined distance of the authentication location comprises determining that the mobile device of the user has been within the predetermined distance of each of the multiple geographic locations.

Furthermore, in some embodiments of the system, the step of receiving user input of multiple geographic locations further comprises receiving a specific order for the multiple geographic locations, and the step of assigning the multiple geographic locations as the authentication location further comprises assigning the specific order for the multiple geographic locations as the authentication location. In some such embodiments, the step of determining that the mobile device of the user is within the predetermined distance of the authentication location comprises determining that the mobile device of the user has been within the predetermined distance of each of the multiple geographic locations.

Some embodiments of the system comprise a step of, in response to generating the authorization code, transmitting an alert over a wireless network to the mobile device of the user to activate the authentication application, causing a user interface of the mobile device to display a notification requesting that the user proceed to the authorization location.

Finally, some embodiments of the invention are directed to receiving input from the mobile device of the user indicating that the user cannot proceed to the authentication location, and in response to receiving the input indicating that the user cannot proceed to the authentication location, transmitting an alert over a wireless network to the mobile device of the user to activate the authentication application, causing a user interface of the mobile device to display a map comprising a visual representation of the authentication location and one or more surrounding locations. In some such embodiments, the system may receive input from the user interface of the mobile device of the user comprising a selection of a region of the map that is associated with the authentication location and, in response to receiving the input comprising the selection of the region of the map that is associated with the authentication location, authenticate the completion of the event.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for location based authentication, in accordance with an embodiment of the invention;

FIG. 2 provides a block diagram illustrating the authentication system of FIG. 1, in accordance with an embodiment of the invention;

FIG. 3 provides a block diagram illustrating the location validation system of FIG. 1, in accordance with an embodiment of the invention;

FIG. 4 provides a block diagram illustrating the mobile device system of FIG. 1, in accordance with an embodiment of the invention;

FIG. 5 provides a flowchart illustrating a process for location based authorization of a user for the completion of an event, in accordance with an embodiment of the invention;

FIG. 6 provides a flowchart illustrating a process for location based authorization of a user for a transfer of funds to the user, in accordance with embodiments of the invention;

FIG. 7 provides a flowchart illustrating a process for location based authorization of a user utilizing a visual representation of locations, in accordance with embodiments of the invention;

FIG. 8 provides a diagram of a display of a visual representation of locations for location based authorization of a user, in accordance with embodiments of the invention; and

FIG. 9 provides a flowchart illustrating a process for location based authorization of a user through an authorization location device, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Embodiments of the present invention provide a system and method for location based authorization of a user and/or an electronic device of the user. The authentication system may be used to authenticate a user for the completion of an event where the identity of the user is important. For example, the event may require that a computing device system transfers sensitive data across a wireless network to one or electronic devices, but the identity of users controlling and/or accessing the electronic devices is not easily ascertained or confirmed. While username, password, challenge questions, and other security measures may be used to identify or confirm an identity of a user, these security measures are not always the most reliable techniques for authentication. In fact, many of these common security measures can be guessed or gleaned from a user and input by a person assuming the identity of the intended user.

While two-step verification techniques have provided one technical solution to improving confidence in an identity of a user accessing an electronic device, they can be improved to provide a higher degree of confidence. Current two-step techniques determine that an intended user needs to be authenticated, and therefore transmit an authentication code or other authenticating data to an electronic device that is known to be associated with the intended user. The intended user can then present this code, input the code, or otherwise provide a confirmation through the authentication code to provide a form of proof that the person is in fact the intended user. However, this form of proof, and the current two-step authentication process in general, relies on the assumption that the intended user is the only person that can access the device to which the authentication code was sent.

Assuming the authentication code is sent to a mobile device of the intended user, the assumption that the intended user is the only person that can access that mobile device is critical to the current two-step verification techniques. In fact, a mobile device, or any electronic device for that matter, can be accessed by individuals other than the intended user, whether by another individual possessing the device, another individual viewing the code as it is sent to the device, or the like.

To resolve this weakness in the security and effectiveness of a two-step authentication technique, the present invention provides several unique technical solutions for increasing a system's confidence in the identity and authorization of an intended user, in scenarios where a user is receiving an authentication code or other sensitive data.

Generally, the present invention provides an authentication application to a user for installation on the mobile device of the user. When the occurrence of an event that requires authentication of the user's identity for the completion of the event is determined, an authentication code is generated. The purpose of the authentication code is to provide a secure code to a mobile device (or any electronic device) that is known to be associated with the user, thereby providing additional support on top of any other identity credentials for a user's claim that they are an intended user. However, instead of immediately sending the authentication code to the computing device of the user, the location of the mobile device of the user is continuously monitored.

For security purposes, the user may have established an authentication location (e.g., a secret place, a safe location, a home, an office, a hotel, and the like) that the user frequents or can proceed to if needed. The current invention leverages the fact that the authentication location is a place that the user frequents by assigning authentication value to a determination that the mobile device of the user is at or within a certain distance of the authentication location. This value is manifested in the assumption that if the mobile device of the user is within a certain distance of the authentication location, then the user is likely in possession of the device at that time. This probability of the identity of the user is definitely higher than merely assuming that a mobile device of the user is always in possession of the user, or that the user is the only person or entity that can access the mobile device.

Therefore, once the monitored location of the mobile device of the user is determined to be at or within a predetermined distance from the authentication location, the authentication code is finally transmitted to the mobile device of the user. This transmission may be time-sensitive, as the likelihood that the intended user is still in possession of the mobile device begins to lessen over time once the mobile device is no longer near the authentication location.

Once the mobile device of the user has received the authentication code, the intended user may present this authentication code to an entity, a merchant, a financial institution, a computer application, a website application, and/or the like to provide the highly-secure authentication process. These individuals and entities that receive the location based authentication code from the user can have a higher degree of certainty than through normal authentication code practices that the person representing themselves as the user is in fact the intended user.

In some embodiments, and for added levels of security, the mobile device of the user must be present at or near multiple authentication locations before the authentication code is transmitted to the mobile device of the user. For example, the multiple authentication locations may be a home address, a work address, and a gym address that are commonly attended by the user. Once the mobile device of the user is detected to be at each of these authentication locations, the authentication code will be sent to the mobile device of the user. By requiring the mobile device of the user to be present at multiple authentication locations before the authentication code is sent, the likelihood that the intended user is in fact in possession of the mobile device is increased. In some embodiments, at least some of the multiple authentication locations must be visited in a specific order before the authentication code is sent to the mobile device of the user. For example, the user may always (or almost always) pass two or more locations in order on the way from a work address to a home address. In such embodiments, the authentication code may not be sent unless and until each of these locations are passed by the mobile device of the user.

In some embodiments, the user may not be able to physically travel to the authentication location within an amount of time necessary or desired to complete an event that requires authentication of the user. In some of these embodiments, a visual representation of the authentication location (e.g., a map, an image, and the like) may be displayed at the mobile device of the user. The user may then make one or more selections on the visual representation to indicate that the individual accessing the mobile device at that time knows the authentication location(s) and therefore likely is the intended user.

Of course, there are additional and alternative techniques for each of the embodiments identified above. Some of these are described in more detail below, while others based on the disclosed embodiments are certainly contemplated.

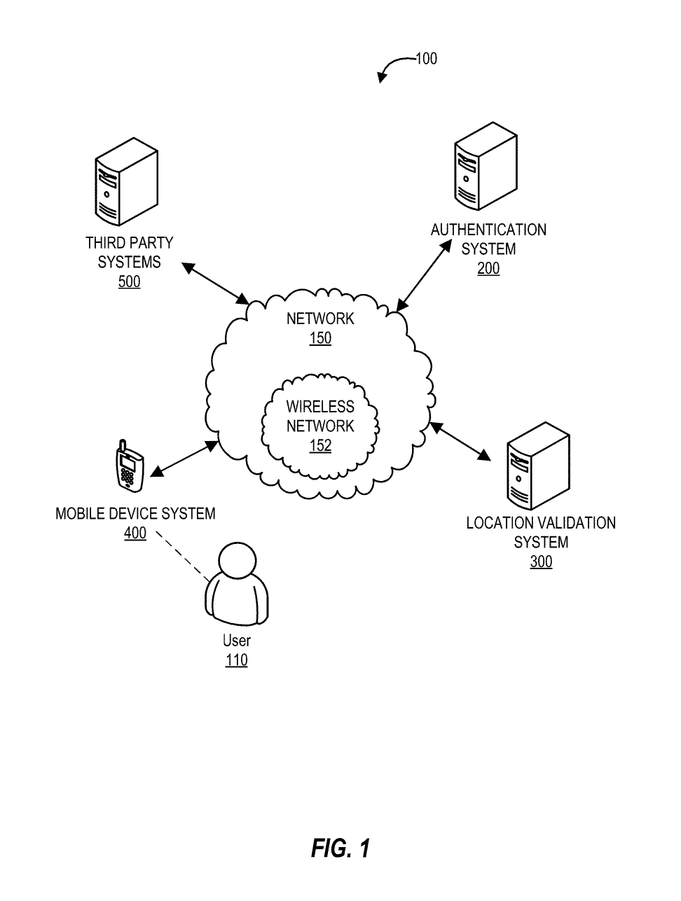

Turning now to the figures, FIG. 1 provides a block diagram illustrating a system and environment 100 for location based authentication, in accordance with an embodiment of the invention. As illustrated in FIG. 1, the environment 100 includes an authentication system 200, a location validation system 300, a mobile device system 400 that is associated with a user 110, and one or more third party systems 120. The user 110 of the system may be an individual person, or may be one or more agents of an entity (e.g., a business, a merchant, and the like). As used herein, the term “user” shall generally mean a person or entity that needs to be authenticated. The user 110

As shown in the system environment 100, the authentication system 200, the location validation system 300, the mobile device system 400, and the third party systems 120 are communicably connected via the network 150, which in some instances may comprise a wireless network 152. The network 150 may include or comprise a local area network (LAN), a wide area network (WAN), and/or a global area network (GAN). The network 150 may provide for wireline, wireless, or a combination of wireline and wireless communication between devices in the network. In one embodiment, the network 150 includes the Internet.

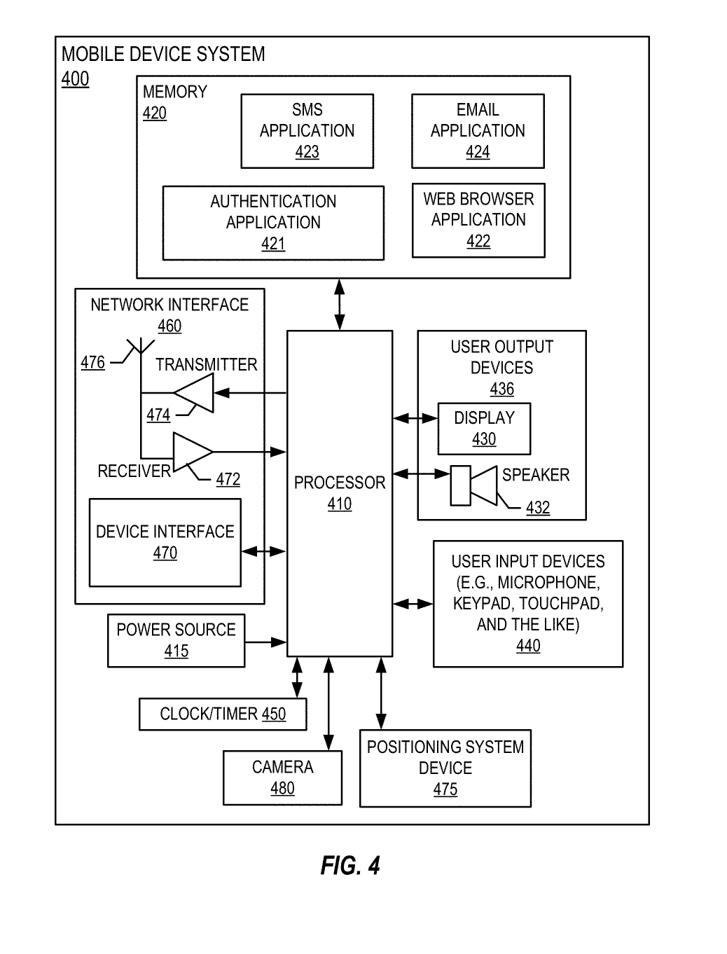

As used herein, a “mobile device” may be any mobile communication device, such as a cellular telecommunications device (i.e., a cell phone or mobile phone), a personal digital assistant (PDA), a mobile Internet accessing device, or other mobile device. The mobile device system 400 is configured to connect with the network 150 to interface the user 110 with an application of the authentication system 200, the location validation system 300, and/or one or more third party systems 120. The mobile device system 400, and its capability to interact with the user 110 and other systems in the system environment 100 will be discussed in greater detail with regard to FIG. 4.

The authentication system 200 is in network communication through the network 150 with other devices, such as the location validation system 300, the mobile device system 400, one or more third party systems 120, and the like. The authentication system 200 may be configured to generate authentication codes, monitor location data associated with the mobile device system 400 or other systems, transmit data (e.g., authentication codes, authentication notifications, and the like) to one or more systems in the system environment 100, and the like.

The authentication system 200 may be configured to transmit commands and/or control signals to one or more systems within the system environment 100. For example, the authentication system 200 may be configured to transmit one or more alerts over the network 150 to the mobile device system 400, wherein the alert activates one or more applications stored in the mobile device system 400 to cause the mobile device system 400 to perform certain tasks. These tasks may include causing a user interface of the mobile device system 400 to display one or more notifications or requests, causing a speaker of the mobile device system 400 to emit one or more audible notifications, causing the mobile device system 400 to be configured to receive certain input from the user 110, and the like. Of course other tasks can be accomplished based on the configuration of the mobile device system 400 and the applications stored within the mobile device system 400.

The authentication system may also provide authentication notifications or otherwise authorize the completion of events, the transfer of funds in a transaction, the transfer of sensitive data, and the like. These authorizations may be based upon or triggered by activities and processes that the authentication system detects, receives, causes, or otherwise interprets within the system environment.

In some embodiments, the authentication system is controlled by, or owned by, a managing entity. The managing entity may be a data security entity, a data transfer entity, a financial entity, a money wiring entity, and the like, or any combination therein.

In one embodiment, the invention may provide an application download server such that software applications that support the authentication system 200 can be downloaded to the mobile device system 400, the third party systems 120, and/or the location validation system 300. In some embodiments, the authentication system comprises the application download server, and provides software applications (e.g., an authentication application) to the user 110 and/or the mobile device system 400 for installation on the mobile device system 400.

In some embodiments of the invention, the application download server is configured to be controlled and managed by one or more third-party data providers (not shown in FIG. 1) over the network 150. In other embodiments, the application download server is configured to be controlled and managed over the network 150 by the same entity or entities that maintains the authentication system 200.

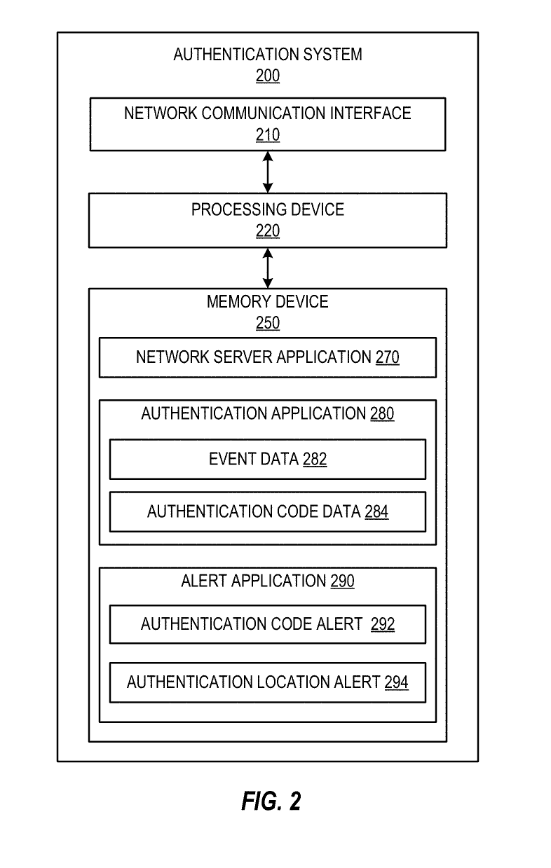

The authentication system 200 and its features and components are described in more detail with respect to FIG. 2.

The location validation system 300 may be controlled and/or managed by the same entity that manages the authentication system 200, or may be controlled and/or managed by one or more third party entities (not shown). In some embodiments, the location validation system 300 is a component of, and therefore could be referred to as, the authentication system 200. The location validation system 300 may be in network communication with the mobile device system 400, the authentication system 200, and/or the one or more third party systems 120 via the network 150. In some embodiments, the location validation system 300 stores data associated with authentication locations, authentication codes, and/or the like.

The location validation system 300 may also comprise location monitoring tools for monitoring one or more devices associated with the system environment 100. For example, the location validation system 300 may be configured to (or may receive command signals that configure the location validation system 300 to) continuously monitor a location of the mobile device system 400. In some embodiments, the location validation system 300 may monitor the location of the mobile device system 400 by receiving global positioning system (GPS) data transmitted by the mobile device system, and associating the received GPS data with known geographic locations.

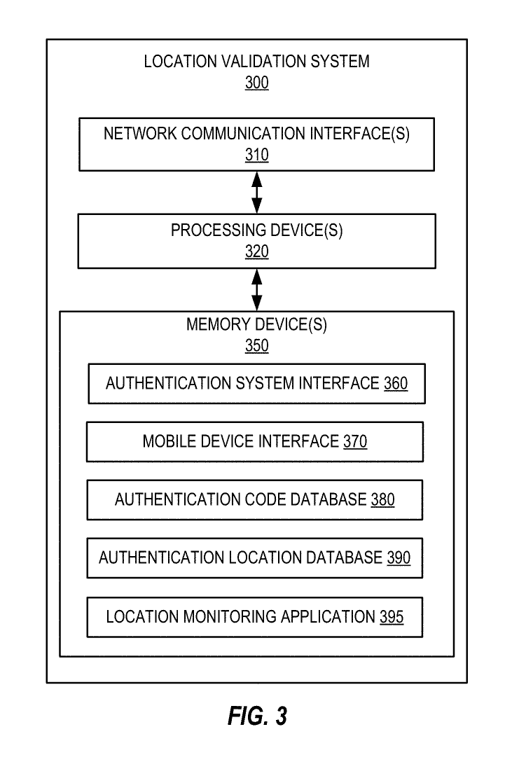

Additionally or alternatively, the location validation system 300 may comprise one or near field communication devices that are configured to detect and recognize signals from the mobile device system 400. For example, the location validation system 300 may include an authentication chip at a known geographic location that is configured to scan for a known signal from the mobile device system 400. In some embodiments, the location validation system 300 may receive and/or transmit authentication codes or other sensitive data associated with the user authentication process. The location validation system 300 is described in more detail with regard to FIG. 3.

The one or more third party systems 120 may comprise any system or device that can be configured to interact with the other systems in the system environment 100. In some embodiments, a third party system 120 comprises a merchant system. The merchant system may be a business or organization associated with some event that requires the authentication of the user 110. As such, the merchant system may comprise a transaction device or other computing device configured to receive an authentication code or other data from the user as part of the authentication process. In some embodiments, the transaction device comprises an automated teller machine (ATM), a point of sale (POS) device, a computing device of a teller, and the like. Of course, in some embodiments, the entity associated with the authentication system 200 may also be associated with the final authentication steps of the user 110, and therefore that managing entity may be in control of the transaction device described above.

In some embodiments, the third party system 120 comprises an online application system that is configured to receive an authorization code or other data from the user 110 and/or the mobile device system 400. In some embodiments, the location validation system 300 is at least partially controlled by or incorporated within a third party system 120. For example, the location validation system 300 may comprise a chip or other physical device that is manufactured and/or sold by a third party entity, but is configured to be utilized by the entity associated with the authentication system 200 to accomplish the tasks set forth herein in its role within the system environment 100.

FIG. 2 provides a block diagram illustrating the authentication system 200, in greater detail, in accordance with embodiments of the invention. As illustrated in FIG. 2, in one embodiment of the invention, the authentication system 200 includes one or more processing devices 220 operatively coupled to a network communication interface 210 and a memory device 250. In certain embodiments, the authentication system 200 is operated by a first entity, such as a financial institution, while in other embodiments, the authentication system 200 is operated by an entity other than a financial institution.

It should be understood that the memory device 250 may include one or more databases or other data structures/repositories. The memory device 250 also includes computer-executable program code that instructs the processing device 220 to operate the network communication interface 210 to perform certain communication functions of the authentication system 200 described herein. For example, in one embodiment of the authentication system 200, the memory device 250 includes, but is not limited to, a network server application 270, an authentication application 280 comprising event data 282 and authentication code data 284, an alert application 290 comprising at least one authentication alert 292 and at least one authentication location alert 294, and other computer-executable instructions or other data. The computer-executable program code of the network server application 270, the authentication application 280, or the alert application 290 may instruct the processing device 220 to perform certain logic, data-processing, and data-storing functions of the authentication system 200 described herein, as well as communication functions of the authentication system 200.

In one embodiment, the authentication application 280 includes event data 282 and authentication code data 284. The event data 282 may comprise stored data associated with one or more events such as transactions or any other transmission of funds or electronic data. The authentication code data 284 may comprise one or more authentication codes generated or received by the authentication application 280. The authentication code data 284 may also comprise a data repository that can be searched to determine if a received authentication code matches the appropriate authentication code stored in the authentication system 200. As such, the network server application 270 and the authentication application 280 are configured to invoke or use the event data 282 and/or the authentication code data 284 when carrying out one or more of the processes described herein.

Similarly, the alert application 290 may include the authentication code alert 292 and the authentication location alert 294. The authentication code alert 292 may comprise one or more stored functions, program readable instructions, or other commands that can be transmitted to a the mobile device system 400, the location validation system 300, or a third party system 120. Likewise, the authentication location alert 294 may comprise one or more stored functions, program readable instructions, or other commands that can be transmitted to a the mobile device system 400, the location validation system 300, or a third party system 120. As such, the network server application 270 and the alert application 290 are configured to invoke or use the authentication code alert 292 and/or the authentication location alert 294 when carrying out one or more of the processes described herein. The authentication code alert 292 and the authentication location alert 294, once transmitted to another device, may be configured to activate one or more applications, like the authentication application 421 of the mobile device system 400, and thereby cause the one or more applications to perform functions associated with their associated systems.

As used herein, a “communication interface” generally includes a modem, server, transceiver, and/or other device for communicating with other devices on a network, and/or a user interface for communicating with one or more customers. Referring again to FIG. 2, the network communication interface 210 is a communication interface having one or more communication devices configured to communicate with one or more other devices on the network 150, such as the mobile device system 400, the location validation system 300, and/or the one or more third party systems 120. The processing device 220 is configured to use the network communication interface 210 to transmit and/or receive data and/or commands to and/or from the other devices connected to the network 150.

FIG. 3 provides a block diagram illustrating a location validation system 300, in accordance with embodiments of the invention. As illustrated in FIG. 3, the location validation system 300 generally includes, but is not limited to, a network communication interface 310, one or more processing devices 320, and one or more memory devices 350. The processing device 320 is operatively coupled to the network communication interface 310 and the memory device 350. In one embodiment of the location validation system 300, the memory device 350 stores, but is not limited to, an authentication system interface 360, a mobile device interface 370, an authentication code database 380, an authentication location database 390, and/or a location monitoring application 395.

The authentication system interface 360 and the mobile device interface 370 may associate with applications having computer-executable program code that instructs the processing device 320 to operate the network communication interface 310 to perform certain communication functions involving the authentication code database 380, the authentication location database 390, and the location monitoring application 395 described herein.

In some embodiments, the authentication code database 380 stores data including, but not limited to, authentication codes received from the authentication system, computer product instructions received from the authentication system 200, and the like. Additionally, the authentication location database 390 stores data including, but not limited to, authentication locations associated with the user 110, device signatures of the mobile device system 400, and the like.

The location monitoring application 395 may be any application capable of being configured to monitor one or more mobile devices (e.g., the mobile device system 400), using any form of positioning data. For example, the location monitoring application 395 may continuously retrieve GPS data associated with the mobile device system 400 to determine a location of the mobile device system 400 at any given point in time. Additionally or alternatively, the location monitoring application 395 may be configured to actively transmit one or more signals that are configured to detect the presence of the mobile device system 400.

The network communication interface 310 is a communication interface having one or more communication devices configured to communicate with one or more other devices on the network 150. The processing device 320 is configured to use the network communication interface 310 to receive information from and/or provide information and commands to a mobile device system 400, an authentication system 200, and/or the one or more third party systems 120 via the network 150.

In some embodiments, the processing device 320 also uses the network communication interface 310 to access other devices on the network 150, such as one or more web servers of one or more third-party data providers. In some embodiments, one or more of the devices described herein may be operated by a second entity so that the second entity controls the various functions involving the location validation system 300. For example, in one embodiment of the invention, although the authentication system 200 is operated by a first entity (e.g., a financial institution), a second entity operates the location validation system 300.

In some embodiments, at least a portion of the location validation system 300 comprises a physical device such as a computing device, a chip, a smart wearable device, an Internet of things device, or the like.

FIG. 4 provides a block diagram illustrating a user's 110 mobile device system 400 of FIG. 1 in more detail, in accordance with embodiments of the invention. In one embodiment of the invention, the mobile device system 400 is a mobile telephone. However, it should be understood that a mobile telephone is merely illustrative of one type of mobile device system 400 that may benefit from, employ, or otherwise be involved with embodiments of the present invention and, therefore, should not be taken to limit the scope of embodiments of the present invention. Other types of mobile device systems 400 may include portable digital assistants (PDAs), pagers, mobile televisions, gaming devices, laptop computers, cameras, video recorders, audio/video player, radio, GPS devices, or any combination of the aforementioned.

Some embodiments of the mobile device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the mobile device system 400. For example, the processor 410 may include a digital signal processor device, a microprocessor device, and various analog to digital converters, digital to analog converters, and/or other support circuits. Control and signal processing functions of the mobile device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the mobile device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the mobile device system 400 may be configured to operate with one or more air interface standards, communication protocols, modulation types, and access types. By way of illustration, the mobile device system 400 may be configured to operate in accordance with any of a number of first, second, third, and/or fourth-generation communication protocols and/or the like. For example, the mobile device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with long term evolution (LTE) protocols, with 3GPP protocols and/or the like. The mobile device system 400 may also be configured to operate in accordance with non-cellular communication mechanisms, such as via a wireless local area network (WLAN) or other communication/data networks.

The network interface 460 may also include a transaction computing device interface 470. The transaction computing device interface 470 may include software, such as encryption software, and hardware, such as a modem, for communicating information to and/or from one or more devices on a network 150 and connected with or that are part of the authentication system 200. For example, the mobile device system 400 may be configured so that it can be used as an interface for interacting with the authentication system 200 for inputting information about one or authentication codes. For example, the mobile device system 400 may wirelessly communicate encrypted activity information to a terminal of the network 150, the authentication system 200 and/or the location validation system 300.

As described above, the mobile device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410. The user input devices 440, which allow the mobile device system 400 to receive data from a user such as the user 110, may include any of a number of devices allowing the mobile device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The mobile device system 400 may also include a positioning system device 475 that is configured to be used by a positioning system to determine a location of the mobile device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate location of the mobile device system 400. In other embodiments, the positioning system device 475 includes a proximity sensor or transmitter, such as a radio-frequency identification (RFID) tag, that can sense or be sensed by devices known to be located proximate a merchant or other location to determine that the mobile device system 400 is located proximate these known devices. The positioning system device 475 may play a crucial role in transmitting location information associated with the mobile device system 400 to the location validation system 300 and/or the authentication system 200.

The mobile device system 400 further includes a power source 415, such as a battery, for powering various circuits and other devices that are used to operate the mobile device system 400. Embodiments of the mobile device system 400 may also include a clock or other timer 450 configured to determine and, in some cases, communicate actual or relative time to the processor 410 or one or more other devices.

The mobile device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the mobile device system 400 and/or one or more of the process/method steps described herein. For example, the memory 420 may include such applications as a conventional web browser application 422 and/or an authentication application 421. These applications also typically provide a graphical user interface (GUI) on the display 430 that allows the first user 110 to communicate with the mobile device system 400, the authentication system 200, and/or other devices or systems. In one embodiment of the invention, when the user 110 decides to enroll in an authentication application 421 program, the user 110 downloads, is assigned, or otherwise obtains the authentication application 421 from the authentication system 200, or from a distinct application server. In other embodiments of the invention, the user 110 interacts with the authentication system 200 or the location validation system 300 via the web browser application 422 in addition to, or instead of, the authentication application 421.

The memory 420 can also store any of a number of pieces of information, and data, used by the mobile device system 400 and the applications and devices that make up the mobile device system 400 or are in communication with the mobile device system 400 to implement the functions of the mobile device system 400 and/or the other systems described herein. For example, the memory 420 may include such data as user authentication information, and the like.

As discussed above, in some embodiments of the invention, an application server or application download server (not shown) might be provided. The application download server may include a network communication interface, a processing device, and a memory device. The network communication interface and processing device are similar to the previously described network communication interface 210 and the processing device 220 previously described with respect to the authentication system 200. For example, the processing device is operatively coupled to the network communication interface and the memory device. In one embodiment of the application download server, the memory device includes a network browsing application having computer-executable program code that instructs the processing device to operate the network communication interface to perform certain communication functions of the application download server described herein. In some embodiments of the invention, the application download server provides applications that are to be downloaded to a user mobile device system 400, to a component of the location validation system 300, and/or to one or more third party systems 120.

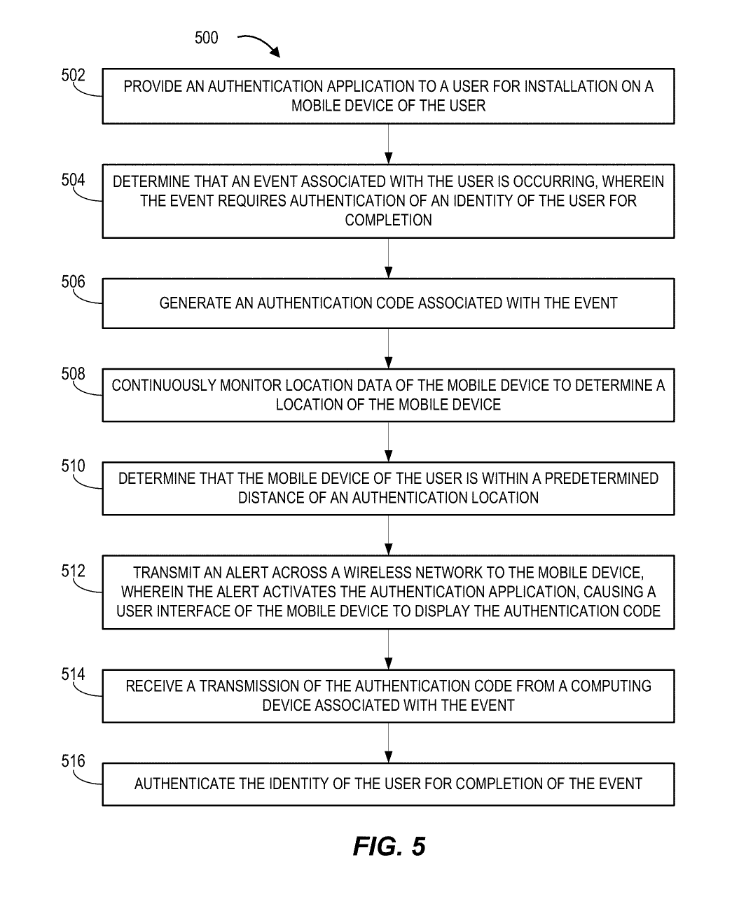

Referring now to FIG. 5, a flowchart is provided to illustrate one embodiment of a process 500 for location based authentication, in accordance with embodiments of the invention. In some embodiments, the process 500 may include block 502, where the system provides an authentication application to a user for installation on a mobile device of the user. In some embodiments, the process 500 includes step 504, where the system determines that an event associated with the user is occurring, wherein the event requires authentication of an identity of the user for completion of the event. As used herein, the term “event” refers to a transaction of funds, a communication of information, or any other electronic transfer of data or information that requires authentication of the identity of the user for completion of the event.

Additionally, in some embodiments, the process 500 includes block 506, where the system generates an authentication code associated with the event. In some embodiments of the invention, the authentication code is generated in direct response to determining that the event associated with the user is occurring. In other embodiments, the system has already generated the authentication code, and the system instead assigns the generated authentication code to the event in response to determining that the event is occurring.

The process 500 may also include block 508, where the system continuously monitors location data of the mobile device to determine a location of the mobile device. In some embodiments, the step of continuously monitoring location data of the mobile device is automatically conducted in response to generating the authentication code.

In some embodiments, the process 500 includes block 510, where the system determines that the mobile device of the user is within a predetermined distance of an authentication location. The authentication location may be any location known to be frequented or otherwise visited by the user. Therefore, when the system determines that the mobile device is located in or within a predetermined distance of the authentication location, the system can make a strong assumption that the user is actually in possession of the mobile device at that moment. This assumption is stronger than the general assumption that a user is always in control of, or is the only individual capable of accessing, the mobile device of the user.

Additionally, in some embodiments, the process 500 includes block 512, where the system transmits an alert across a wireless network to the mobile device, wherein the alert activates the authentication application, causing a user interface of the mobile device to display the authentication code. In some embodiments, the step at block 512 occurs in response to the determination that the mobile device of the user is within the predetermined distance of the authentication location.

The process 500 may include block 514, where the system receives a transmission of the authentication code from a computing device associated with the event. Finally, the process 500 may include block 516, where the system authenticates the identity of the user for completion of the event. In some embodiments, the system authenticates the identity of the user in direct response to receiving the transmission of the authentication code.

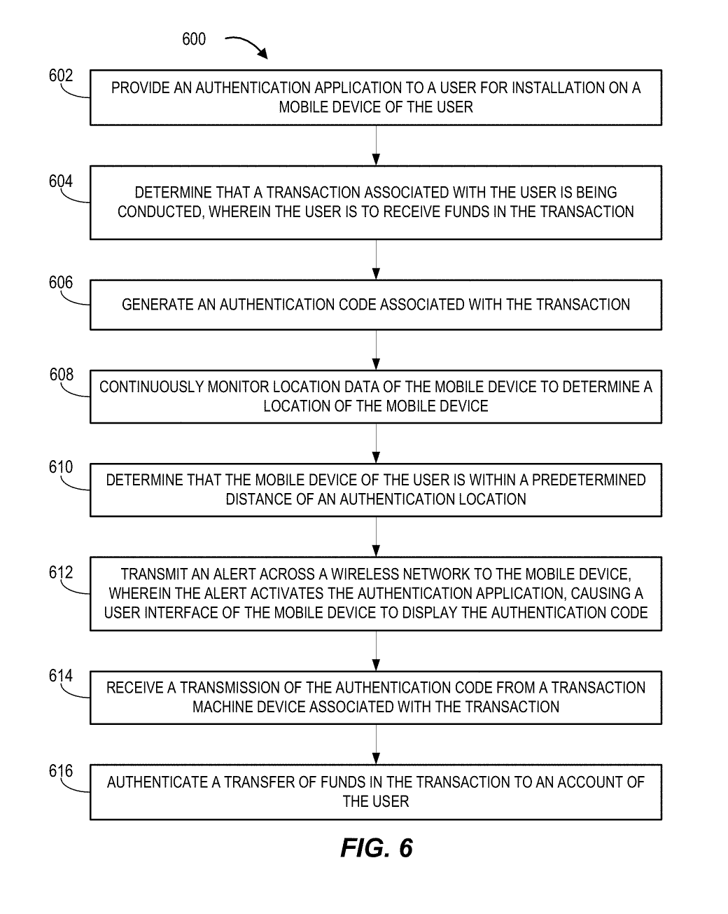

Referring now to FIG. 6, a flowchart is provided to illustrate one embodiment of a process 600 for location based authentication of a user for the transfer of funds to an account of the user as a result of a transaction, in accordance with embodiments of the invention. This process 600 may be particularly useful in scenarios where an individual or an entity sender desires to transfer funds to an intended user, but the sender requires or wants to ensure that the intended user is the actual recipient of the funds.

For example, the process 600 may be useful in authenticating a user for wire transfer of funds, a long distance or international remittance, a bank transfer, a credit transfer, or any other electronic funds transfer. As described above, some current wire transfer processes include a two-step verification process with a first step of requiring the person receiving the funds to present identification credentials (e.g., a photo identification card, a reference number, a personal identification number (PIN), and the like). The second step is to transmit an authentication code to a device associated with the intended recipient (i.e., the user), and the user is required to present this authentication code to a teller or an online application to further authenticate the user as the intended user in the transfer of funds. The present process 600, and similar processes described herein, provide an additional layer of security and confidence in confirming the recipient of the funds is in fact the authorized user by implementing a location based authentication process for the transmission of the authentication code.

In some embodiments, the process 600 may include block 602, where the system provides an authentication application to a user for installation on a mobile device of the user. This authentication application may be controlled by or otherwise managed by an authentication entity, a financial institution, a security entity, a wire transfer entity, and/or the like. The authentication application, or copies of the authentication application, may be stored in one or more databases of an authentication entity, a third party entity, or the like. In some embodiments, the authentication application may be stored on memory drives that can be provided to one or more users for downloading the authentication application to the mobile devices of those users. An online application managed by the authentication entity, a financial institution, or a third party entity, may provide an online venue that allows users to view information regarding the authentication application and download the authentication application to the mobile device of the user.

In some embodiments, the authentication entity may transmit the authentication application to the mobile device of the user in response to a request or approval from the user to receive the authentication application for downloading on the mobile device of the user. In some embodiments, the authentication application may transmit code configured to cause the mobile device of the user to download the authentication application.

After the user has download the authentication application onto the mobile device of the user, a notification may be transmitted back to the authentication application confirming that the mobile device of the user now has the authentication application downloaded and stored within its memory.

In some embodiments, the authentication application may be continuously running in the background and/or the foreground of the mobile device of the user. In other embodiments, the authentication application may be passively running in the background, or may be dormant as a stored application in the memory of the mobile device. The authentication application may be activated by alerts transmitted from the authentication system, the location validation system, and/or third party systems. These alerts may also be configured to cause the authentication application, once activated, to cause one or more functions of the mobile device to occur. For example, the authentication application may cause a user interface of the mobile device to display visual notifications, emit audible notifications via a speaker, vibrate, transmit data to one or more devices in communication with the mobile device, and/or the like. The authentication application may also cause the user interface of the mobile device to be configured to receive input from the user or any individual accessing the mobile device. These functions may be stored in the authentication application when it is downloaded onto the mobile device of the user. Additionally or alternatively, these functions may be communicated to the authentication application by one or more alerts or command signals from the authentication system or another system.

As part of the installation process for the authentication application, the system may request, retrieve, or otherwise ascertain one or more authentication locations that will be associated with the authentication application. For example, the system, in response to providing the authentication application, may transmit an authentication alert to the mobile device of the user, wherein the authentication location alert activates the authentication application, causing a user interface of the mobile device to display a request for input of a geographic location to be assigned as the authentication location. This authentication location may be stored locally within the mobile device of the user, in a database associated with an authentication system, in a database associated with a location validation system, and/or in a database associated with one or more third party systems. The display provided at the user interface of the mobile device may comprise a map, input fields, and the like. For example, the system may display a map of the mobile device's current location, and allow the user to select one or more authentication locations on the map. Additionally or alternatively, the system may provide text input fields where the user may input one or more physical addresses, position coordinates, and the like.

In some embodiments, the authentication location is a known location of a merchant, agent, or wire transfer company that the user uses to complete these types of transactions. For example, the user may provide an input of an address, GPS coordinates, or other information associated with the location of a place where the user will always go to receive funds from such a transfer. As such, the system may set the authentication location as this location.

In some embodiments, the system may retrieve location data associated with the mobile device of the user, and/or the user in general, to identify one or more locations that the user frequents. These frequented locations may be displayed on a map, in a visual display notification, or the like, on the mobile device of the user, where the mobile device is configured to receive input from the user of a selection and/or approval of one or more of the frequented locations as the authentication location(s). The system may also provide recommended authentication locations based on other information. For example, the authentication system may already have a home address associated with the user stored, based on a financial account maintained by the user. This home address can be presented to the user as a potential authentication location, where the user can select or approve the potential authentication location. In this manner, the system may utilize machine learning logic to track user behavior through the mobile device of the user, thereby identifying certain locations that could be relatively secure authentication locations based on the habits of the user.

In a similar way, the machine learning logic may track location data related to the mobile device of the user over time to determine if an authentication location remains secure or otherwise valid for use in the authentication process. For example, if a mobile device of the user is not detected to be at or near a certain authentication location for a predetermined period of time (e.g., a week, a month, and the like), then the authentication system may remove the authentication location from a stored list of authentication locations. In some embodiments, the system may transmit a notification to the mobile device of the user to request consent to remove the authentication location or to prompt the user to provide an alternative authentication location.

When the user selects a single geographic location as the authentication location through input to the mobile device of the user (or through any other device associated with the user), the system can receive, from the mobile device of the user, the input of the geographic location and assign the selected geographic location as the authentication location.

When the user selects multiple geographic locations as the authentication locations through input to the mobile device of the user, the system can receive, from the mobile device of the user, the user input of the multiple geographic locations and then assign the multiple geographic locations as the authentication locations. In some such embodiments, the user may select multiple authentication locations in a particular order, which may be an important aspect of the process 600 as described below. For example, the user may select two authentication locations, where a first authentication location must be visited before a second authentication is visited. The specific sequence authentication locations may be associated with a common route of travel for the user, or otherwise provides an additional layer of certainty that the user is in fact in possession of the mobile device. Therefore, the system may store the multiple authentication locations with the specific order of the locations being tied to the stored authentication location data.

In some embodiments, multiple authentication locations may be stored and associated with the mobile device of the user, but the number of these multiple authentication locations may vary based upon an authentication tier or level associated with the user at any given point in time. For example, a first or low tiered authentication level may allow each of the identified multiple authentication locations to be actively associated with the mobile device of the user. However, if the authentication level of the user is raised to a second or high tiered authentication level, the system may restrict the available authentication locations to one or two locations that have been identified by the user and/or the system to be the most trust-worthy indicators of the user's possession of the mobile device.

While several embodiments described herein refer to a single “authentication location,” it should be known that multiple authentication locations are contemplated in each embodiment, where feasible.

The authentication locations stored by the system may change or vary over time, either based on time of day, day of the week, and/or day of the year restrictions, or based on travel scenarios of the user. For example, if the user has travelled away from the user's authentication locations, and cannot easily proceed to these locations, the user may be able to input one or more temporary or alternative authentication locations in the region where the user has travelled to. For example, the user may input an address or GPS coordinates of a hotel that the user is staying in as the temporary authentication location, and may be associated with a length of time and/or a time of day that the temporary authentication location is to be considered valid.

The system may also retrieve a stored predetermined distance that is to be associated with the authentication location. In other embodiments, the system may allow the user to customize the distance from the authentication location that will be utilized by the process 600 at a later point in time. This distance from the authentication location may be important for confirming that the mobile device of the user is actually at the authentication location, and therefore is very likely in possession of the mobile device. The predetermined distance from the authentication location may be different for different authentication locations and/or different types of authentication locations. For example, the predetermined distance from an authentication location of the user's house address may be wider than the predetermined distance from the authentication location of the user's work address, because the user may move around the house address location much more than the user's office location. The predetermined distance from each authentication location may vary based on other factors as well. For example, the allowed predetermined distance from an authentication location may shrink in response to a determination that a higher standard or tier of user authorization is required.

In some embodiments, the process 600 includes step 604, where the system determines that a transaction associated with the user is being conducted, wherein the user is to receive funds as a result of the transaction. While this process 600 refers to one embodiment of a transaction that involves the transfer of funds, the term “transaction,” as generally used herein, shall refer to any communication of data, electronic funds, authorization of a transfer of data or funds, and the like.

In some embodiments, the system determines that a transaction is being conducted by receiving an indication of a request for funds to be transferred from a sender to an intended user from a POS device, an ATM, an online application, or other device or application associated with a transfer of funds. In some embodiments, information associated with the intended user may be received or identified as a result of the transaction. For example, the sender may input a name of the intended user, along with any other known identification information such as a phone number, a financial account number, an email address, a physical address, a username, and the like. This information may be utilized later in the process 600 when a teller, a transaction device, and/or an online application authenticates the user with a first step of authentication (e.g., a teller may request a photo identification card of the user, an address of the user, and the like).

In some embodiments, the system may receive an indication that the user is an intended recipient of the transaction, and the system may then retrieve information associated with the user that is already stored in one or more databases associated with the system. For example, the system may be managed by a financial institution that is associated with the user. Therefore, when the system receives a request to transfer funds to a financial account owned or managed by the user, the system can access data associated with that user and/or that financial account.

Several of the above described factors, including the authentication location, the predetermined distance from the authentication location, and the like, can be adjustable or variable due on time-based reasons. For example, an authentication of a user's work address may only be valid during weekdays and during normal working hours of the user.

Additionally, in some embodiments, the process 600 includes block 606, where the system generates an authentication code associated with the transaction. In some embodiments, the system generates the authentication code in direct response to determining that the transaction is being conducted. In other embodiments, the system has already generated the authentication code, and the system instead assigns the generated authentication code to the transaction in response to determining that the transaction is being conducted.

After generating and/or assigning the authentication code, the system may store the authentication code and any other known identification information associated with the user, the mobile device of the user, the transaction, the sender, and the like, in a data repository for cross-matching verification at a later point in time. In some embodiments, the authentication code is stored in a product remittance repository database.

The authentication code may be numeric, alpha-numeric, a security image, a scannable bar code, a scannable quick response (QR) code, and the like. The purpose of the authentication code is to provide an added layer of security and validation to aide an individual or an application in confirming within a certain degree of confidence that an individual requesting the transferred funds is in fact the intended recipient. This authentication code can be used as a second layer of authentication, on top of a first authentication step of user identity credentials like a photo identification, a username and/or password, and the like.

Although the authentication code has been generated and/or assigned to the user, the system may not immediately transmit the authentication code to the mobile device of the user. Instead, the system may store the authentication code in a database, where the authentication code can be transmitted to the mobile device of the user at a later point time, in response to one or more triggering events. Instead, some embodiments of the invention involve transmitting a “dummy” code, or other code that is not the actual authentication code, to the mobile device of the user. This dummy code may be an invalid code that is presented to the user for security purposes. In some embodiments, the dummy code acts as a common authentication code in a two-factor authentication process, but requires a stricter authorization clearance for the first authentication factor. For example, the dummy code may help to allow a user to receive funds from the transaction, but requires additional strict identification credentials like multiple photo identification cards, a birth certificate, finger prints or other biometric input, and the like. This may be different from the actual authentication code generated by the system, where the first authentication factor may be a less stringent identification credential such as a single photo identification card, an account number, or the like.

A failsafe code may also be generated and transmitted to the user, through the mobile device or otherwise. This failsafe code may be another false code or a header code that can be attached to the dummy code and/or the authentication code. The failsafe code, when presented to the authentication system, can indicate that the transaction should not be carried out, that additional authorization is required, or that authorities should be notified regarding the transaction.

The system may also inform the user that the user must proceed to the authentication location to receive the generated authentication code. As such, in some embodiments of the invention, in response to generating the authorization code, the system may transmit an alert over a wireless network to a mobile device of the user to activate the authentication application, causing a user interface of the mobile device to display a notification requesting that the user proceed to the authorization location. In some such embodiments, the system may also transmit the dummy code to the mobile device of the user.

The process 600 may also include block 608, where the system continuously monitors location data of the mobile device to determine a location of the mobile device. In some embodiments of the invention, the system may begin the monitoring process in response to generating the authentication code. The system may monitor the location of the mobile device of the user, and record or otherwise store data associated with one or more physical geographic locations associated with the positioning data of the mobile device.

In some embodiments, the system may receive and track GPS data associated with a positioning system device of the mobile device of the user. In other embodiments, the system may ping the mobile device of the user continuously, near continuously, or periodically to request location information of the mobile device. In some embodiments, the mobile device of the user is configured by the authentication application to transmit position data associated with the mobile device to the system.

The positioning data may include data associated with near-field communications between the mobile device and one or more devices with a known location. For example, the mobile device may transmit a location report to the system in response to connecting to a Wi-Fi router at a known location. Similarly, the mobile device may transmit a location report to the system in response to detecting a signal generated by a near field communication (NFC) chip, a Bluetooth device, or other device that has a known location, or is otherwise known to be associated with the user.

In some embodiments, the process 600 includes block 610, where the system determines that the mobile device of the user is within a predetermined distance of an authentication location. As used herein, the term “authentication location” generally refers to a physical location that is known to the user and/or the system as a location that the user frequents or otherwise visits. The purpose of the authentication location is to provide a physical space in which the presence of a mobile device associated with the user tends to support an assumption that the user is in fact in possession of the mobile device. For example, if the authentication location is a home of the user, then other individuals likely are not in possession of the user's mobile device when the user is at home, because the mobile device is likely not lost and likely is not missing. Therefore, when the system determines that the mobile device of the user is located within the home, or within a predetermined distance from the home, the system has a higher degree of confidence that the user is actually in possession of the device than when the mobile device of the user is detected in a different location like a public park. This higher degree of confidence in the identity of the possessor of the mobile device is leveraged by the process 600 to create a more secure and protected transfer of the authentication code.

Examples of potential authentication locations may include a home address of the user, an office address of the user, a school address associated with the user, an address of a business, a vacation home address of the user, a hotel address of the user, and the like. Additionally or alternatively, the system may have received a pin drop from the mobile device of the user that indicates a certain location that should be considered the authentication location.

In some embodiments of the system, the mobile device of the user is associated with multiple authentication locations. In these embodiments, the system may make the determination that the mobile device of the user is within a predetermined distance of one of the multiple authentication locations. In other embodiments, the system may require that the mobile device of the user is within a predetermined distance from two or more of the multiple authentication locations, wherein the mobile device is present at each location at some point in time, but obviously not necessarily at the same time. Furthermore, in some embodiments, the system may require that the mobile device of the user is detected within a predetermined distance from two or more of the multiple authentication locations, but in a specific order (e.g., the home address of the user, then the work address of the user, then the school address of the user, then the home address of the user again).

As described above, the authentication location may change or otherwise be valid only during certain times of the day, days of the week, and/or days of the year. For example, an authentication location of a work address may only be a valid authentication during common working hours, on common working days for the user. As such, the system may not determine that the user is within the predetermined distance of the authentication location if the mobile device is detected at the work address of the user on a non-working day.

As described above, the predetermined distance associated with the authentication location may vary based on a time of day, day of the week, day of the year, and the like. For example, the predetermined distance from an authentication location of a home address for the user may expand during the day to encompass a yard, or other surrounding features where the user (and therefore the mobile device of the user) may commonly be located to perform chores, to sit on a porch, and the like. However, the predetermined distance from the same authentication location of a home address may reduce to encompass only a few rooms in the house of the user during the night, as the user is most commonly in a kitchen, den, or bedroom during the nighttime hours. As such, the system may take time and date information into account when determining whether the user is within the predetermined distance from the authentication location.

Additionally, in some embodiments, the process 600 includes block 612, where the system transmits an alert across a wireless network to the mobile device, wherein the alert activates the authentication application, causing a user interface of the mobile device to display the authentication code. In some embodiments, the system executes block 612 in response to determining that the mobile device of the user is within the predetermined distance of the authentication location. If the system does not determine that the mobile device of the user is within the predetermined distance of the authentication application, then the system may never transmit the alert, and therefore never sends the authentication code to the mobile device of the user.

The authentication code may be displayed as a numeric code, an alpha-numeric code, an image, a scannable QR code, a scannable bar code, a word or phrase, a password, a signal, and/or the like. In some embodiments, the system merely notifies the user that the authentication code has been transmitted to the mobile device of the user, but does not present the code until the mobile device is prompted to do so by the user and/or a teller or other entity that needs to receive the authentication code to authenticate the user as the intended recipient of the transfer of funds. Additionally or alternatively, the transmitted authentication code may comprise a signal that is transmittable by the mobile device of the user. As such, the user may be able to present the mobile device of the user to a transaction machine associated with completing the transaction, where the mobile device of the user transmits the signal to the transaction machine to authenticate the user. Therefore, the user may never actually view the authentication code, but the mobile device of the user will receive the authentication code and can store the authentication code for the subsequent authentication step.

In some embodiments, the system may transmit a notification to a device associated with the user that is different from the mobile device of the user, where the notification informs the user that an authentication code has been transmitted to the mobile device of the user. This notification can serve to provide an additional assurance that the authentication code has in fact been received by the intended recipient of the transaction.

The process 600 may include block 614, where the system receives a transmission of the authentication code from a transaction machine associated with the transaction. While the process 600 describes the use of a transaction machine to complete the transaction, it should be known that some embodiments involve authenticating a user through an online application or physically by a teller at a financial institution or wire transfer company. Ultimately, the authentication code is conveyed by the user and/or the mobile device of the user to the transaction machine, the teller, and/or the online application as a form of authentication of the identity of the user as the intended recipient in the transaction. In some embodiments, the user may also be required to provide other forms of identification (e.g., a photo identification card, a password, a PIN, a money tracking number, an account number, and the like), as is required in some two-factor authentication steps.

In some embodiments, the transaction machine may scan the authentication code from the mobile device of the user (e.g., in scenarios where the authentication code comprises a bar code or a QR code). In other embodiments, the transaction machine and/or the system may prompt the mobile device of the user to transmit the authentication code to the transaction machine and/or an authentication system as proof that the user is in possession of the authentication code. This transmission may comprise a transfer across the Internet, over a wireless computer network, through near field communication (e.g., Bluetooth, Wi-Fi, radio wave signals, and the like) to the transaction machine. The transaction machine may then receive the authentication code.

Finally, the process 600 may include block 616, where the system authenticates a transfer of funds in the transaction to an account of the user. In some embodiments, the system authenticates the transfer of funds in direct response to receiving the authentication code from the transaction machine associated with the transaction. In other embodiments, the system authenticates the transfer of funds in response to matching the received authentication code to the transmitted authentication code. If the transmitted authentication code and the received authentication code do not match, the system may deny the authentication of the user, and the transaction may not go through.

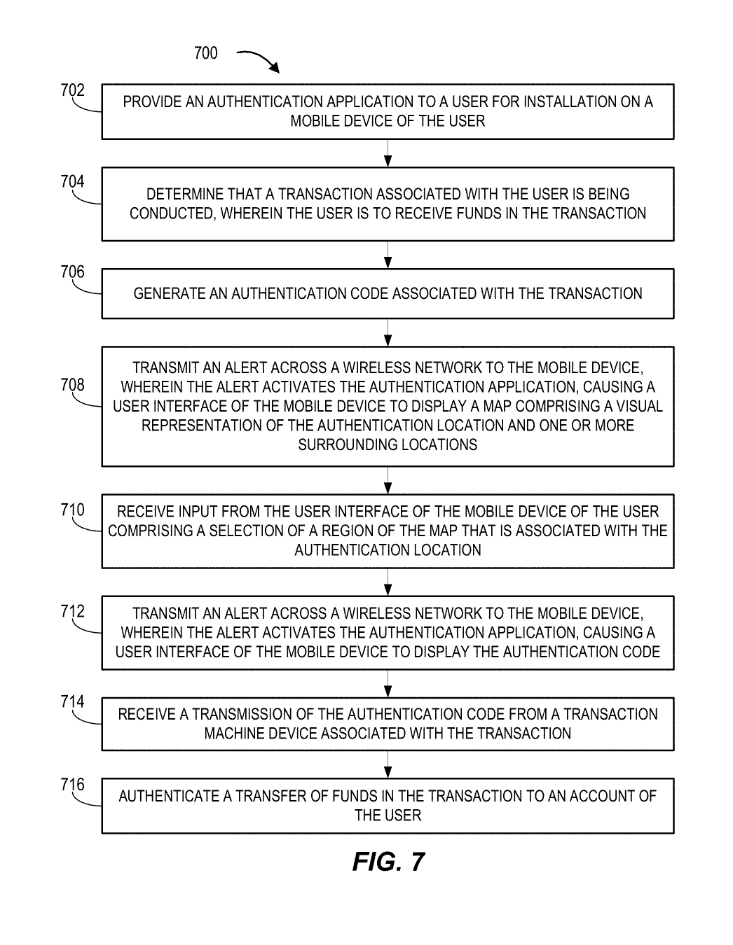

Referring now to FIG. 7, a flowchart is provided to illustrate one embodiment of a process 700 for location based authentication of a user using a visual representation of one or more authentication locations, in accordance with embodiments of the invention. In some embodiments, the process 700 may include block 702, where the system provides an authentication application to the user for installation on a mobile device of the user. In some embodiments, the process 700 includes step 704, where the system determines that a transaction associated with the user is being conducted, wherein the user is to receive funds as a result of the transaction. Additionally, in some embodiments, the process 700 includes block 706, where the system generates an authentication code associated with the transaction. In some embodiments, the system generates the authentication code in response to determining that the transaction is being conducted. In other embodiments, the system has already generated the authentication code, and the system instead assigns the generated authentication code to the transaction in response to determining that the transaction is being conducted. In some embodiments, these blocks 702-706 of the process 700 may be the same or similar to the blocks 602-606 of process 600 described above.

The process 700 may also include block 708, where the system transmits an alert across a wireless network to the mobile device, wherein the alert activates the authentication application, causing a user interface of the mobile device to display a map comprising a visual representation of the authentication location and one or more surrounding locations. In some embodiments, the system executes block 708 in response to generating the authentication code.

The system may transmit this alert to cause the mobile device to display the map in response to receiving an indication from the user or the mobile device of the user that the user is unable to proceed to the authentication location. This may be due to the fact that the user is out of town, and therefore not near any authentication location, or any other factor that may limit the user's movement or access to the authentication location.

In other embodiments, this map-based authentication process 700 may be the only type of authentication based on location, and any determination of the physical presence of the mobile device of the user at the actual authentication locations does not trigger any actions on the part of the system. Furthermore, this map-based authentication process 700 may allow a user to select authentication locations that are not normally reachable by the user. For example, the user may select locations that are many miles apart, on different continents, are associated with tourist landmarks, are associated with special family locations, and the like. In such embodiments, the user may be able to select a landmark from the map that serves as an authentication location. The system may also store one or more predetermined distances from the authentication locations as distances from a point on a touch-screen of the mobile device of the user and/or as digital representations of actual distances from a landmark or other map-based authentication location.

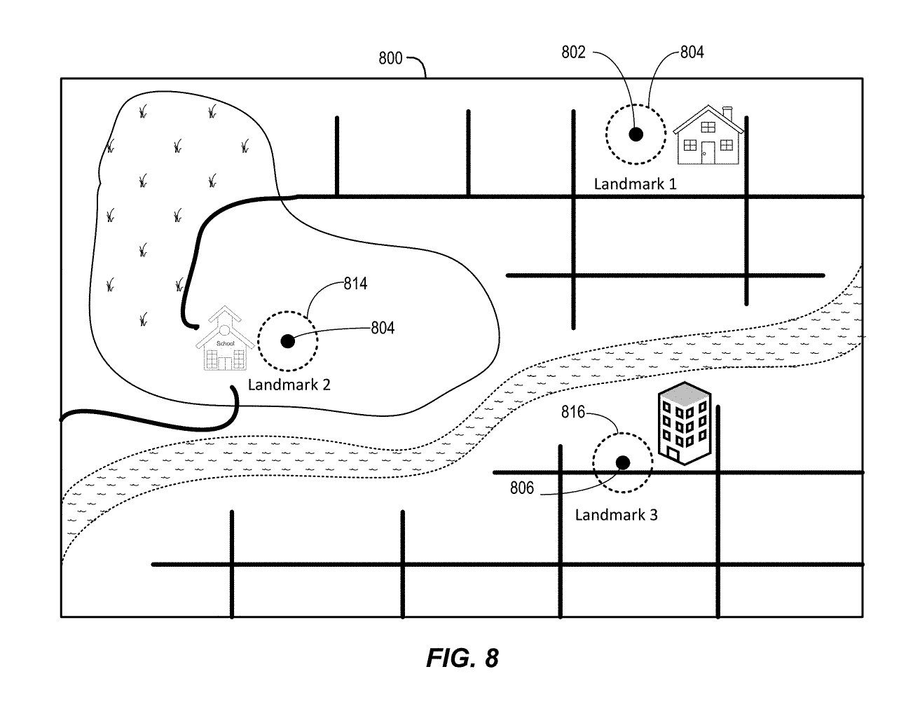

In some embodiments, the system may display the visual representation of the authentication location(s) and surrounding areas in the manner shown in FIG. 8. The display 800 in FIG. 8 may display a visual representation of a certain region that may contain the authentication location of the user. For example, in embodiments where Landmark 1 is the authentication location, the system may provide the display 800 without the identified authentication locations 802, 804, and 806, or the predetermined distances from the authentication locations 812, 814, and 816. Therefore, when the system causes the user interface of the mobile device of the user to display the visual representation of the authentication location as described with respect to block 708, the user will see a clean map. The system can then configure the user interface of the mobile device to receive one or more inputs from the user.

For example, the system may configure the user interface of the mobile device to receive touch-screen input from the user associated with one or more positions on the display 800. Therefore, when the user touches the touch-screen display 800 within the predetermined distance 812 of the precise location 802 of Landmark 1, the system can receive this input as a correct selection of the authentication location.

In embodiments with multiple authentication locations, the system may be configured to receive multiple inputs from the mobile device of the user, where the user can select each of Landmark 1, Landmark 2, and Landmark 3 by touching areas on the display 800 within the predetermined distances 812, 814, and 816 of the precise authentication locations 802, 804, and 806. Of course, in embodiments where the order of selecting authentication locations is important for the authentication of the user, the system may require that the user selects the authentication locations in that precise order before determining that the user has appropriately selected the authentication locations.

In some embodiments, the process 700 includes block 710, where the system receives input from the user interface of the mobile device of the user comprising a selection of a region of the map that is associated with the authentication location. As described above, system may receive a touch-screen selection of one or more authentication locations visible on the display 800. Additionally or alternatively, the user may input coordinates, a location name, or the like into the mobile device of the user. The received input may be compared to stored authentication location information to determine whether the received input is acceptable as identifying the authentication location. If the system determines that the inputted authentication location is a match, then the system may progress with the process 700 (or in some embodiments the process 600) in the same manner as if the system determined that the mobile device of the user is located within the predetermined distance from the authentication location.

Additionally, in some embodiments, the process 700 includes block 712, where the system transmits an alert across a wireless network to the mobile device, wherein the alert activates the authentication application, causing a user interface of the mobile device to display the authentication code. In some embodiments, the system executes block 712 in response to receiving the input from the user interface of the mobile device of the user comprising the selection of the region of the map that is associated with the authentication location. The process 700 may include block 714, where the system receives a transmission of the authentication code from a transaction machine device associated with the transaction. Finally, the process 700 may include block 716, where the system authenticates a transfer of funds in the transaction to an account of the user. In some embodiments, the system authenticates the transfer of funds in response to receiving the transmission of the authentication code from the transaction machine device. In some embodiments, the system authenticates the transfer of funds in response to determining that the received authentication code and the transmitted authentication code match. Blocks 712-716 may be the same or similar to blocks 612-616, described above with respect to FIG. 6.

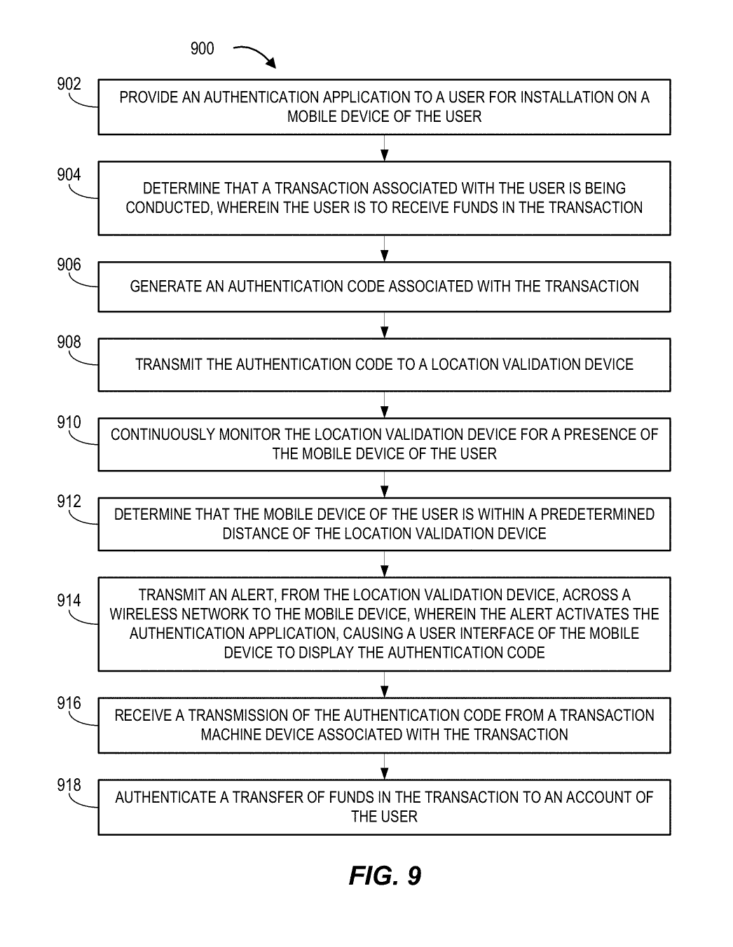

Referring now to FIG. 9, a flowchart is provided to illustrate one embodiment of a process 900 for location based authentication utilizing a location validation device, in accordance with embodiments of the invention. In some embodiments, the process 900 may include block 902, where the system provides an authentication application to a user for installation on a mobile device of the user. In some embodiments, the process 900 includes step 904, where the system determines that a transaction associated with the user is being conducted, wherein the user is to receive funds in the transaction. Additionally, in some embodiments, the process 900 includes block 906, where the system generates an authentication code associated with the transaction. In some embodiments, the system generates the authentication code in response to determining that the transaction is being conducted. In other embodiments, the system has already generated the authentication code, and the system instead assigns the generated authentication code to the transaction in response to determining that the transaction is being conducted. The blocks 902-906 may be the same or similar to the blocks 602-606 of the process 600 described above with respect to FIG. 6.

The process 900 may also include block 908, where the system transmits the authentication code to a location validation device. In some embodiments, the system transmits the authentication code to the location validation device in response to generating and/or assigning the authorization code. As used herein, the term “location validation device” refers to any computing device, processing device, chip, or the like, that is capable of receiving instructions from the system and can be configured to communicate with or detect the mobile device of the user. The location validation device may also be capable of receiving and storing data such as the authentication code generated by the system. Therefore, the system may transmit the authentication code to the location validation device, where the code may be stored until the mobile device of the user is detected at the location validation device.

The location validation device may be owned or managed by an authentication entity associated with the system, a financial institution associated with the system, or the like. In some embodiments, the location validation device may be a device manufactured and/or sold by one of these entities or a third party entity, but currently owned or managed by the user. The user may position the location validation device in a building, home, car, or other location that the user frequents or otherwise visits. As such, the location validation device serves as an authentication location for the process 900. Therefore, in some embodiments of the invention (e.g., the processes 500, 600, 700, and 900), the authentication location may be the location where the location validation device is located at any point in time.

The location validation device may be a stationary device that does not move from some location to which it is secured or otherwise positioned. For example, the location validation may be a smart device like a smart thermostat, a speaker system connected to the Internet via Wi-Fi or Bluetooth, and the like, associated with a home or office. In this manner, the location validation device may be any device of the “Internet of things” that can connect to one or more other devices like the mobile device of the user via wireless connections. In some embodiments, the location validation device may be a moveable device other than the mobile device of the user. For example, the location validation device may be a chip, smart watch, or other device that is not necessarily constantly paired with the mobile device. In such embodiments, the user may be able to transport the mobile location validation device to different regions when the user travels, and keep the location validation device in a hotel room, office room, or other location where the user likely will frequent while away from the user's normal region.

Because the location of the location validation device may be important to the authentication process, the system may provide one or more techniques for monitoring the location validation device. For example, the location validation device may comprise a GPS transceiver that communicates a positioning signal to the location validation system or the authentication system. In other embodiments, the location validation device may comprise a different location determination device. The authentication system and/or the location validation device may continuously monitor the location of the location validation device to determine whether the location validation device is in an authentication location or is otherwise secure.

Once the location validation device receives the authentication code, the location validation device may store the authentication code in one or more memory devices. Instead of immediately transferring the authentication code to the mobile device of the user, the location validation device will wait until it detects a presence of the mobile device of the user.

Therefore, in some embodiments, the process 900 includes block 910, where the system continuously monitors the location validation device for a presence of the mobile device of the user. In some embodiments, the system executes block 910 in response to transmitting the authentication code to the location validation device.

As such, the location validation device may comprise one or more monitoring devices that can be configured to detect the mobile device of the user. For example, the location validation device may comprise a Bluetooth device that actively and continuously searches for a Bluetooth signal from the mobile device of the user. Additionally or alternatively, the location validation device may continuously search for an identification signal of the mobile device of the user.

In some embodiments, the location validation device does not necessarily comprise a monitoring device, but instead is configured to receive an input from the user (e.g., a push of a button, a fingerprint scan or other biometric identifier, or the like). In response to receiving the user input, the location validation device may determine that the user is present.

Additionally, in some embodiments, the process 900 includes block 912, where the system determines that the mobile device of the user is within a predetermined distance of the location of the location validation device. Once the location validation device identifies a signal or other identifying characteristic of the mobile device of the user, the location validation device can make the determination that the mobile device of the user is in fact at or within a predetermined distance from the location validation device. As with the authentication location, the fact that the mobile device of the user is at or near the location validation device provides a strong indication that the user is in possession of the mobile device because the location of the location validation device is known to be frequented by the user.

The process 900 may include block 914, where the system transmits an alert, from the location validation device, across a wireless network to the mobile device, wherein the alert activates the authentication application, causing a user interface of the mobile device to display the authentication code. In some embodiments, the system executes block 914 in response to determining that the mobile device of the user is within a predetermined distance of the location of the location validation device.

The alert of block 914 may be transmitted directly from the location validation device to the mobile device of the user via a wireless communication network, including via a near field communication network, such that the mobile device is configured to receive the authentication code while the mobile device is within a certain vicinity of the location validation device. By transmitting the authentication code to the mobile device while the mobile device is still near the location validation device, the system helps to ensure that the user is the likely possessor of the mobile device when the authentication code is transmitted. As with block 612 of the process 600, the authentication code may be immediately displayed on the mobile device of the user, may be displayed in response to an input from the user, and/or may be displayed once the user initiates completion of the transaction at a teller, a transaction machine, or an online application.

In some embodiments, in response to transmitting the authentication code to the mobile device of the user, the location validation device may transmit another notification to a different device in the system, such as a managing authentication system device, a transaction device, or a third party device, that indicates that the authentication code has successfully been transmitted.

While some embodiments where the location validation device is the device that stores and transmits the authentication code to the mobile device of the user, it should be noted that other embodiments comprise the location validation device determining the location of the mobile device, and transmitting notifications to the rest of the system to cause a different device (e.g., a device associated with an authentication system) to transmit the authentication code to the mobile device of the user.

Furthermore, the process 900 may include block 916, where the system receives a transmission of the authentication code from a transaction machine device associated with the transaction. Finally, the process 900 may continue to block 918, where the system authenticates a transfer of funds in the transaction to an account of the user. In some embodiments, the system authenticates the transfer of funds in response to receiving the transmission of the authentication code from the transaction machine device. In other embodiments, the system authenticates the transfer of funds in response to determining that the transmitted authentication code and the received authentication code match. Blocks 916 and 918 may be the same or similar to blocks 614 and 616 of the process 600 described with respect to FIG. 6.

In some embodiments of the invention, the authentication of the user is based on a tiered authentication system. In such embodiments, factors like the specific authentication locations, the predetermined distance from the authentication locations that are considered part of the authentication location, the timing of the location determination step, and the like, are variable based on the level of authentication required to complete the event or to transfer the funds.

In some embodiments of the invention, the system may also store a non-authentication location, where the system determines that based on the presence of the mobile device in a location that is a non-authentication location, the transaction should be stopped and one or more entities should be notified of an issue with the transaction. For example, authorities may be contacted and provided the non-authentication location and/or the current location of the mobile device of the user, as a result of the mobile device of the user being in a non-common location.

In some embodiments, instead of transmitting an authentication code, the system may transmit a coupon or other reward associated with the user and the event. As such, the processes described herein can be used in an incentive program for having a user attend certain locations.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for location-based authentication, the system comprising:
a memory device; and
one or more processing devices operatively coupled to the memory device, wherein the one or more processing devices are configured to execute computer-readable program code to:
provide an authentication application to a user for installation on a mobile device of the user;
determine that an event associated with the user is occurring, wherein the event requires authentication of an identity of the user for completion;
in response to determining that the event is occurring, generate an authentication code associated with the event;
in response to generating the authentication code associated with the event, transmit the authentication code to a location validation device located at an authentication location;
in response to generating the authentication code, cause the location validation device to continuously monitor location data of the mobile device to determine a location of the mobile device;
determine that the mobile device of the user is within a predetermined distance of the authentication location by receiving an indication that the mobile device of the user is detected by the location validation device;
in response to determining that the mobile device of the user is within the predetermined distance of the authentication location, automatically cause the location validation device to transmit an alert across a wireless network to the mobile device of the user, wherein the alert activates the authentication application, causing a user interface of the mobile device to display the authentication code;
receive a transmission of the authentication code from a transaction computing device associated with the event; and
in response to receiving the transmission of the authentication code, authenticate the identity of the user for completion of the event.

2. The system of claim 1, wherein the one or more processing devices are configured to execute computer-readable program code to:
in response to providing the authentication application, transmit an authentication location alert to the mobile device of the user, wherein the authentication location alert activates the authentication application, causing a user interface of the mobile device to display a request for input of a geographic location to be assigned as the authentication location.

3. The system of claim 2, wherein the one or more processing devices are configured to execute computer-readable program code to:
receive, from the mobile device of the user, the input of the geographic location; and
assign the geographic location as the authentication location.

4. The system of claim 2, wherein the one or more processing devices are configured to execute computer-readable program code to:
receive, from the mobile device of the user, user input of multiple geographic locations; and
assign the multiple geographic locations as the authentication location.

5. The system of claim 4, wherein determining that the mobile device of the user is within the predetermined distance of the authentication location comprises determining that the mobile device of the user has been within the predetermined distance of each of the multiple geographic locations by receiving indications that the mobile device of the user is detected by location validation devices located at each of the multiple geographic locations.

6. The system of claim 4, wherein:
receiving user input of multiple geographic locations further comprises receiving a specific order for the multiple geographic locations;
assigning the multiple geographic locations as the authentication location further comprises assigning the specific order for the multiple geographic locations as the authentication location; and
wherein determining that the mobile device of the user is within the predetermined distance of the authentication location comprises determining that the mobile device of the user has been within the predetermined distance of each of the multiple geographic locations by receiving indications that the mobile device was detected by location validation devices located at each of the multiple geographic locations.

7. The system of claim 1, wherein the one or more processing devices are configured to execute computer-readable program code to:
in response to generating the authentication code, transmit an alert over a wireless network to the mobile device of the user to activate the authentication application, causing a user interface of the mobile device to display a notification requesting that the user proceed to the authentication location.

8. (canceled)

9. A computer program product for location-based authentication, the computer program product comprising at least one non-transitory computer readable medium comprising computer readable instructions, the instructions comprising instructions for:
providing an authentication application to a user for installation on a mobile device of the user;
determining that a transaction associated with the user is being conducted, wherein the user is to receive funds in the transaction;
in response to determining that the transaction is being conducted, generating an authentication code associated with the transaction;
in response to generating the authentication code associated with the transaction, transmitting the authentication code to a location validation device located at an authentication location;
in response to generating the authentication code, causing the location validation device to continuously monitor location data of the mobile device to determine a location of the mobile device;
determining that the mobile device of the user is within a predetermined distance of the authentication location by receiving an indication that the mobile device of the user is detected by the location validation device;
in response to determining that the mobile device of the user is within the predetermined distance of the authentication location, automatically causing the location validation device to transmit an alert across a wireless network to the mobile device of the user, wherein the alert activates the authentication application, causing a user interface of the mobile device to display the authentication code;
receiving a transmission of the authentication code from a transaction computing device; and
in response to receiving the transmission of the authentication code, authenticating a transfer of the funds in the transaction to an account of the user.

10. The computer program product of claim 9, wherein the computer readable instructions further comprise instructions for:
in response to providing the authentication application, transmitting an authentication location alert to the mobile device of the user, wherein the authentication location alert activates the authentication application, causing a user interface of the mobile device to display a request for input of a geographic location to be assigned as the authentication location.

11. The computer program product of claim 10, wherein the computer readable instructions further comprise instructions for:
receiving, from the mobile device of the user, the input of the geographic location; and
assigning the geographic location as the authentication location.

12. The computer program product of claim 10, wherein the computer readable instructions further comprise instructions for:
receiving, from the mobile device of the user, user input of multiple geographic locations; and
assigning the multiple geographic locations as the authentication location.

13. The computer program product of claim 12, wherein determining that the mobile device of the user is within the predetermined distance of the authentication location comprises determining that the mobile device of the user has been within the predetermined distance of each of the multiple geographic locations by receiving indications that the mobile device of the user is detected by location validation devices located at each of the multiple geographic locations.

14. The computer program product of claim 12, wherein:
receiving user input of multiple geographic locations further comprises receiving a specific order for the multiple geographic locations; and
assigning the multiple geographic locations as the authentication location further comprises assigning the specific order for the multiple geographic locations as the authentication location; and
wherein determining that the mobile device of the user is within the predetermined distance of the authentication location comprises determining that the mobile device of the user has been within the predetermined distance of each of the multiple geographic locations by receiving indications that the mobile device was detected by location validation devices located at each of the multiple geographic locations.

15. The computer program product of claim 9, wherein the computer readable instructions further comprise instructions for:
in response to generating the authentication code, transmitting an alert over a wireless network to the mobile device of the user to activate the authentication application, causing a user interface of the mobile device to display a notification requesting that the user proceed to the authentication location.

16. (canceled)

17. A computer implemented method for location-based authentication, said computer implemented method comprising:
providing an authentication application to a user for installation on a mobile device of the user;
determining that a transaction associated with the user is being conducted, wherein the user is to receive funds in the transaction;
in response to determining that the transaction is being conducted, generating an authentication code associated with the transaction;
in response to generating the authentication code associated with the transaction, transmitting the authentication code to a location validation device located at an authentication location;
in response to generating the authentication code, causing the location validation device to continuously monitor location data of the mobile device to determine a location of the mobile device;
determining that the mobile device of the user is within a predetermined distance of the authentication location by receiving an indication that the mobile device of the user is detected by the location validation device;
in response to determining that the mobile device of the user is within the predetermined distance of the authentication location, automatically causing the location validation device to transmit an alert across a wireless network to the mobile device of the user, wherein the alert activates the authentication application, causing a user interface of the mobile device to display the authentication code;
receiving a transmission of the authentication code from a transaction computing device; and
in response to receiving the transmission of the authentication code, authenticating a transfer of the funds in the transaction to an account of the user.

18. The computer implemented method of claim 17, wherein the computer implemented method further comprises:
in response to providing the authentication application, transmitting an authentication location alert to the mobile device of the user, wherein the authentication location alert activates the authentication application, causing a user interface of the mobile device to display a request for input of a geographic location to be assigned as the authentication location;
receiving, from the mobile device of the user, the input of the geographic location; and
assigning the geographic location as the authentication location.

19. The computer implemented method of claim 17, wherein the computer implemented method further comprises:
in response to providing the authentication application, transmitting an authentication location alert to the mobile device of the user, wherein the authentication location alert activates the authentication application, causing a user interface of the mobile device to display a request for input of a geographic location to be assigned as the authentication location;
receiving, from the mobile device of the user, user input of multiple geographic locations; and
assigning the multiple geographic locations as the authentication location;
wherein determining that the mobile device of the user is within the predetermined distance of the authentication location comprises determining that the mobile device of the user has been within the predetermined distance of each of the multiple geographic locations by receiving indications that the mobile device of the user is detected by location validation devices located at each of the multiple geographic locations.

20. The computer implemented method of claim 17, wherein the computer implemented method further comprises:
in response to providing the authentication application, transmitting an authentication location alert to the mobile device of the user, wherein the authentication location alert activates the authentication application, causing a user interface of the mobile device to display a request for input of a geographic location to be assigned as the authentication location;
receiving user input of multiple geographic locations further comprises receiving a specific order for the multiple geographic locations;
assigning the multiple geographic locations as the authentication location further comprises assigning the specific order for the multiple geographic locations as the authentication location; and
wherein determining that the mobile device of the user is within the predetermined distance of the authentication location comprises determining that the mobile device of the user has been within the predetermined distance of each of the multiple geographic locations by receiving indications that the mobile device was detected by location validation devices located at each of the multiple geographic locations.

21. The system of claim 1, wherein the transaction computing device is not located at the authentication location.

22. The computer program product of claim 9, wherein the transaction computing device is not located at the authentication location.
